(19) United States
(12) Patent Application Publication
(10) Pub. No.: US 2018/0050840 A1
(43) Pub. Date: Feb. 22, 2018

(54) MAGNETIC TOOL SYSTEM AND METHOD

(71) Applicant: Donald Bentley, Tyler, TX (US)

(72) Inventor: Donald Bentley, Tyler, TX (US)

(21) Appl. No.: 15/680,180

(22) Filed: Aug. 17, 2017

Related U.S. Application Data
(60) Provisional application No. 62/376,339, filed on Aug. 17, 2016.

(51) Int. Cl. B65D 25/10; B25H 3/02; B65D 43/16

(52) U.S. Cl. CPC B65D 25/10; B65D 43/163; B25H 3/02

(57) ABSTRACT

A tool organization system includes a plurality of magnets, and a container. The plurality of magnets may be arranged in a set, and the container may be configured to house the plurality of magnets arranged in the set. The plurality of magnets may include at least one aperture, wherein each aperture includes a countersink on at least one side of said aperture. Alternately, an adhesive backing may be configured to attach to a non-magnetic surface.

### CROSS-REFERENCE TO RELATED APPLICATION(S)

The present application is related to and claims priority to U.S. Provisional Patent Application No. 62/376,339 filed Aug. 17, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of storage of existing art and more specifically relates to tool magnet systems.

### RELATED ART

A tool box is a crucial component for virtually any craftsman. Over a lifetime of work a craftsman can accumulate a vast multitude of tools which require a suitable form of storage. The conventional tool box has the immediate drawback of becoming messy and disorganized. With many people owning tools numbered in the hundreds, it's no surprise that their tool box often becomes a cluttered mess. Many tool boxes are outfitted with several drawers and trays to help manage organization. These drawers and trays are useful for keeping similar tools separate from each other by allowing a user to assign a drawer to only wrenches or only screwdrivers for example.

Some tool boxes come with integrated organizational components such as foam or plastic inserts in their drawers with cutouts shaped to fit specific tools in a specific place. Others come with flanges built into their drawers to maintain tools in their positions when not in use. The organizational implementations mentioned above all share a common drawback; while they are acceptable means for storing several tools separately, they are not suitable for storing a specific set of tools together in an orderly fashion. When faced with similar jobs over an extended period of time, a user would often benefit from being able to store their most used tools together in an easy to use, organized fashion. A suitable solution is desired.

U.S. Pub. No. 2005/0247585 to Claude Breckwoldt et al. relates to a lid for storing a tool. The described lid for storing a tool includes a base portion having a wall portion along a periphery of the base portion and a magnet portion positioned on the base portion with the magnet portion adapted to hold a metal portion of a tool.

### SUMMARY OF THE INVENTION

In view of the foregoing disadvantages inherent in the known tool magnet systems art, the present disclosure provides a novel magnetic tool system. The general purpose of the present disclosure, which will be described subsequently in greater detail, is to provide a magnetic tool system for efficient storage of tools.

A tool organization system is disclosed herein. The tool organization system includes a plurality of magnets, and a container. The plurality of magnets may be arranged in a set, and the container may be configured to house the plurality of magnets arranged in the set. The plurality of magnets may include at least one aperture wherein each aperture includes a countersink on at least one side of the aperture. Alternately, an adhesive backing may be configured to attach to a non-magnetic surface.

At least one of the plurality of magnets may have sufficient surface area to hold a plurality of fastening hardware such as small nails, screws, bolts, etc., and alternately, at least one of the plurality of magnets may have sufficient surface area to hold a standard hammer. Each of the plurality of magnets has an outer perimeter circumscribing an axis of polarity, and each of the plurality of magnets may include a peripheral coating on said outer perimeter the plurality of magnets.

The plurality of magnets may be configured with a beveled edge configured to be one-fourth inch in width from a forward-facing position, and may even further be configured to be coated in phosphorescent paint. The peripheral coating of each of the plurality of magnets may include phosphorescent paint to easily see tool outlines in low light conditions. The container may be configured to house the plurality of magnets arranged in the set. The container may have a volume at least large enough to house at least one sets of the plurality of magnets. The plurality of magnets may be configured to be individually movable for arranging the plurality of magnets on a planar surface in any combination desired by a user.

According to another embodiment, a method of using a tool organization system is also disclosed herein. The method of using a tool organization system includes attaching a plurality of magnets to a planar surface, arranging the plurality of magnets in a desired configuration, attaching a tool to a forward face of the plurality of magnets, identifying the tool attached to the forward face of the plurality of magnets by the illumination of a phosphorescent paint, removing the tool as needed from the forward face of the plurality of magnets, and storing a plurality of magnets in a container.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a magnetic tool system, constructed and operative according to the teachings of the present disclosure.

FIG. 1 is a perspective view of the tool organization system during an ‘in-use’ condition, according to an embodiment of the disclosure.

FIG. 2 is a perspective view of the tool organization system of FIG. 1, according to an embodiment of the present disclosure.

FIG. 3A is a back view of the tool organization system of FIG. 1, according to an embodiment of the present disclosure.

FIG. 3B is a front view of the tool organization system of FIG. 1, according to an embodiment of the present disclosure

FIG. 4 is a side view of the tool organization system of FIG. 1, according to an embodiment of the present disclosure.

FIG. 5 is a flow diagram illustrating a method of using the tool organization system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a tool magnet system and more particularly to a magnetic tool system as used to improve the organization of a toolbox and visibility of tools in low light situations.

Generally speaking, the tool magnet system is a convenient way to store commonly used tools for easy access. The magnet system is simple; various pound weights of magnets are used for a stronger or lighter hold depending on how much a respective tool weighs. This system is diverse and can work in many environments. Metal tool boxes on the back of trucks may have stored tools that are hard to reach into from the sides, where things tend to get lost and jumbled around.

The magnet is specially designed to have a wide top with a thinner base since most tools have a similar shape, and the present invention comprises a beveled edge which allows a person to pull the magnet off easily. Magnets can be tough to remove when they are flat against a surface, and the beveled edge provides a way to grasp and remove the magnet. Another feature is the plastic ring around the outside which glows in the dark. This allows a user to see a silhouette of the tool in the dark and still know which tool he/she is grabbing and where to put it back. Two countersink holes have been added so the magnets can be attached to wood, and double-sided tape may be included for any surface.

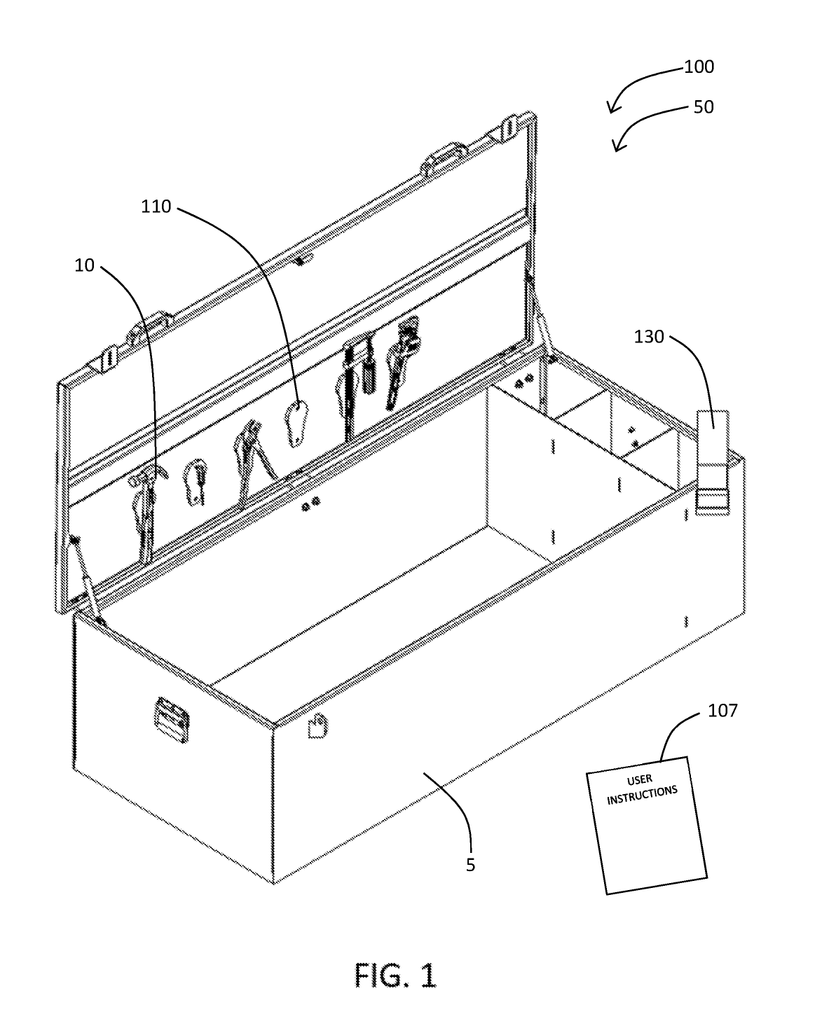

Referring now more specifically to the drawings by numerals of reference, there is shown in FIGS. 1-4, various views of a tool organization system 100.

FIG. 1 shows a tool organization system 100 during an ‘in-use’ condition 50, according to an embodiment of the present disclosure. Here, the tool organization system 100 may be beneficial for use by a user 40 (not shown) to organize a toolbox and increase visibility of tools in low light situations. As illustrated, the tool organization system 100 may include a plurality of magnets 110, and a container 130. The plurality of magnets 110 are arranged magnetically on the under-side of a metal tool box 5. Various tools 10 are held in place by the plurality of magnets 110. The plurality of magnets 110 are arranged in a user 40 (not shown) defined order. The plurality of magnets 110 may have sufficient surface area to hold a plurality of tools 10. The container 130 may include a volume at least large enough to house at least one set of the plurality of magnets 110. The container 130 may be configured to house the plurality of magnets 110 arranged in a set.

According to one embodiment, the tool organization system 100 may be arranged as a kit 105. In particular, the tool organization system 100 may further include a set of instructions 107. The instructions 107 may detail functional relationships in relation to the structure of the tool organization system 100 such that the tool organization system 100 can be used, maintained, or the like, in a preferred manner.

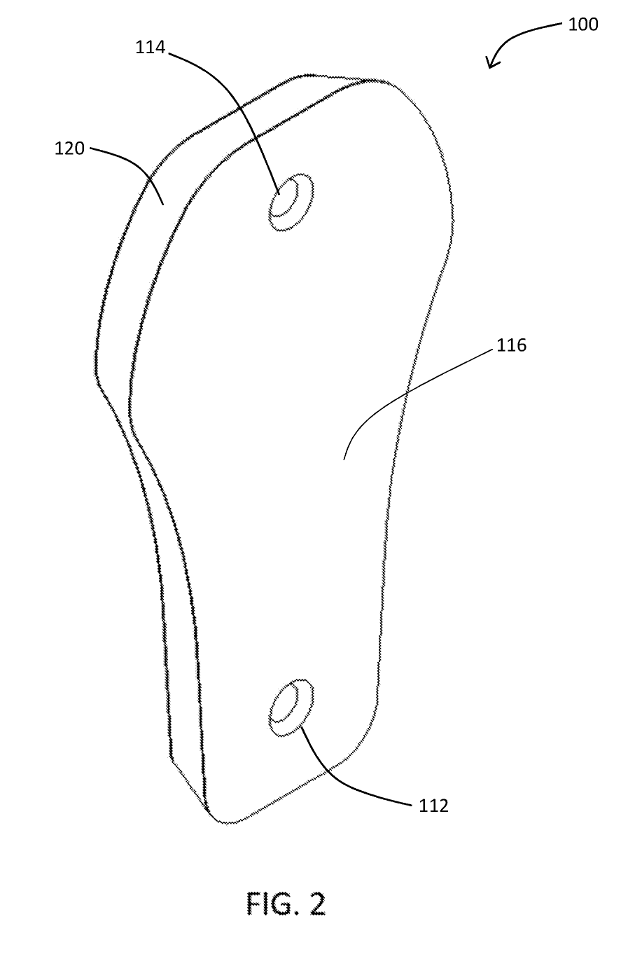

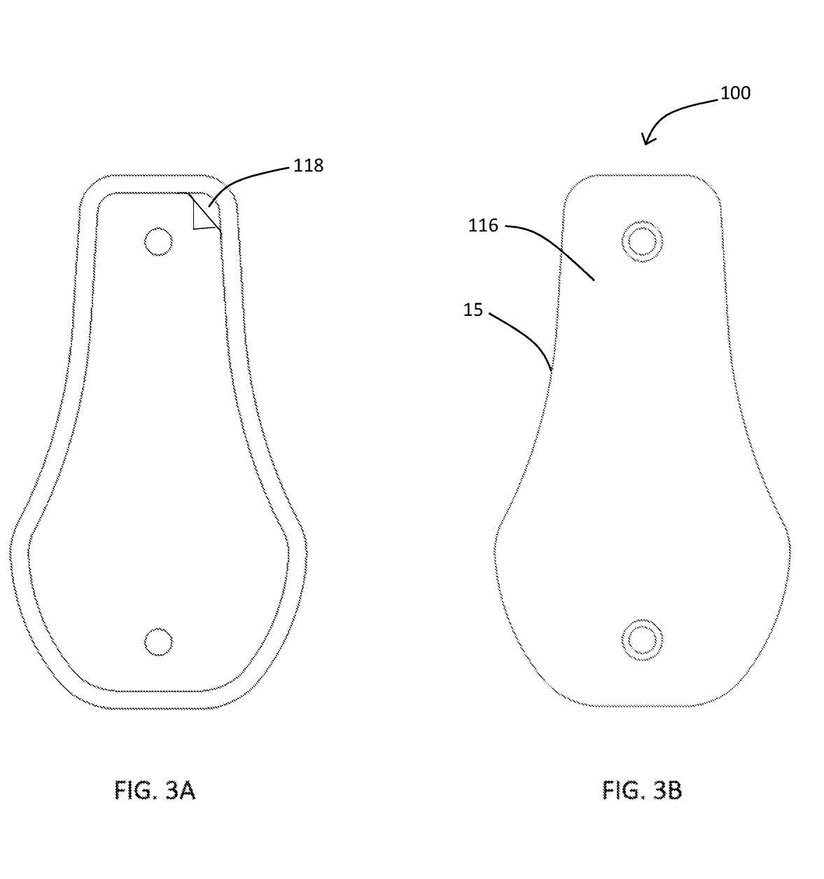

FIG. 2 shows the tool organization system 100 of FIG. 1, according to an embodiment of the present disclosure. As above, the tool organization system 100 may include a plurality of magnets 110, and a container 130. The plurality of magnets 110 may include at least one aperture 112. The at least one aperture 112 includes a countersink hole 114 such that if the plurality of magnets 110 are mounted with screws, they will be flush to the forward face 116. Alternately as shown in FIG. 3A, an adhesive backing 118 may be used to attach the plurality of magnets 110 to a non-magnetic surface. The plurality of magnets 110 may be configured with a beveled edge 120 so that the plurality of magnets 110 may be easily removed from a planar surface. The plurality of magnets 110 are configured to be individually movable for arranging the plurality of magnets 110 on a planar surface in any combination desired by a user 40 (not shown).

FIG. 3A is a back view of the tool organization system of FIG. 1, according to an embodiment of the present disclosure. The beveled edge 120 may be one-fourth inch in width from a forward-facing position. Each of the plurality of magnets 110 may have an outer perimeter circumscribing an axis of polarity, and each of the plurality of magnets 110 includes a peripheral coating of phosphorescent paint 15 on the outer perimeter.

FIG. 3B is a front view of the tool organization system of FIG. 1, according to an embodiment of the present disclosure. The beveled edge 120 may be configured to be coated in phosphorescent paint 15. Alternately, a set of phosphorescent plastic rings 122 may be removably couplable along the outer perimeter of one of the plurality of magnets 110.

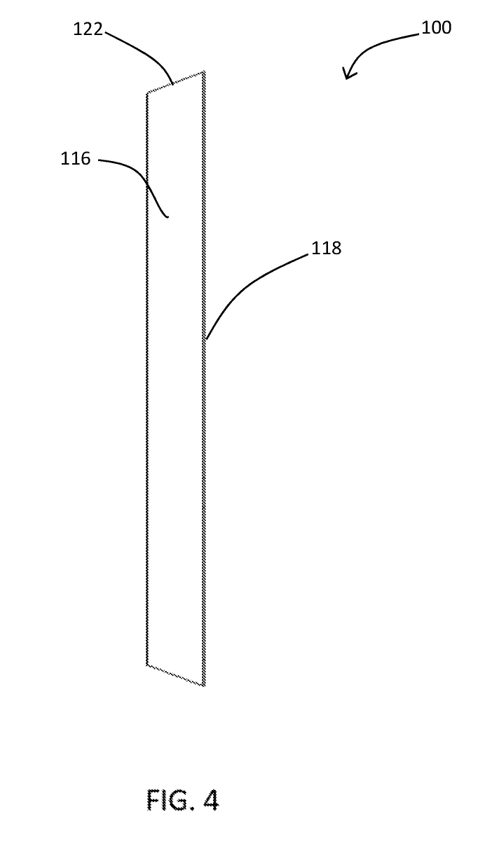

FIG. 4 is a side view of the tool organization system of FIG. 1, according to an embodiment of the present disclosure. The set of phosphorescent plastic rings 122 may be configured to be biodegradable. The set of the phosphorescent plastic rings 122 may be individually colored in at least one of a plurality of colors.

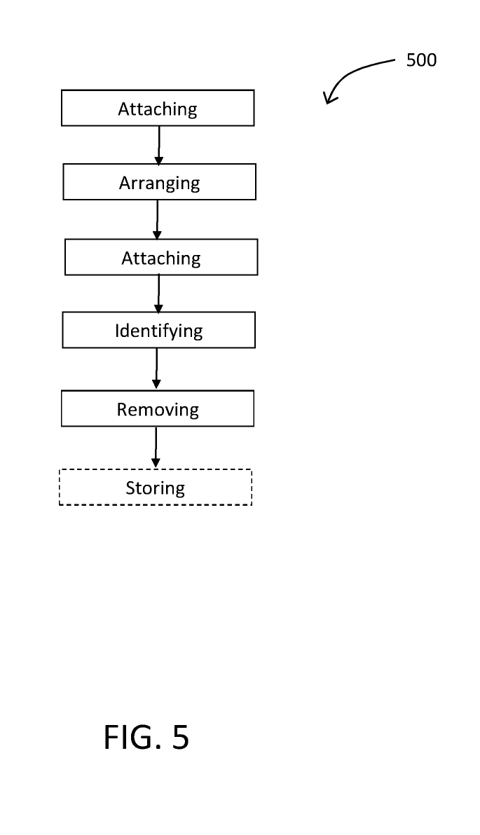

FIG. 5 is a flow diagram illustrating a method 500 for using a tool organization system 100, according to an embodiment of the present disclosure. In particular, the method for using 500 a tool organization system 100 may include one or more components or features of the tool organization system 100 as described above. As illustrated, the method 500 for using a tool organization system 100 may include the steps of: step one 501, attaching a plurality of magnets to a planar surface; step two 502, arranging the plurality of magnets in a desired configuration; step three 503, attaching a tool to a forward face of the plurality of magnets; step four 504, identifying the tool attached to the forward face of the plurality of magnets by the illumination of a phosphorescent paint; step five 505, removing the tool as needed from the forward face of the plurality of magnets; and step six 506, storing a plurality of magnets in a container.

It should be noted that step 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using a tool organization system, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A tool organization system comprising:
a plurality of magnets arranged in a set; and
a container configured to house the plurality of magnets arranged in the set such that said tool organization system is able to be organized and stored in a convenient manner via said plurality of magnets.

2. The system of claim 1, wherein each of the plurality of magnets includes at least one aperture.

3. The system of claim 1, wherein at least one of the plurality of magnets has sufficient surface area to hold a plurality of fastening hardware.

4. The system of claim 3, wherein at least one of the plurality of magnets has sufficient surface area to hold a standard hammer.

5. The system of claim 1, wherein the container has a volume at least large enough to house at least one set of the plurality of magnets.

6. The system of claim 1, wherein each of the plurality of magnets has an outer perimeter circumscribing an axis of polarity, and each of the plurality of magnets includes a peripheral coating on said outer perimeter.

7. The system of claim 6, wherein the peripheral coating of each of the plurality of magnets includes phosphorescent paint.

8. The system of claim 7, wherein the peripheral coating of each of the plurality of magnets includes reflective paint.

9. The system of claim 1, wherein the plurality of magnets are configured to be individually movable for arranging the plurality of magnets on a planar surface in any combination desired by a user.

10. The system of claim 1, wherein the plurality of magnets are configured with a beveled edge configured to be one-fourth inch in width from a forward facing position.

11. The system of claim 10, wherein the beveled edge is configured to be coated in phosphorescent paint.

12. The system of claim 6, further comprising a set of phosphorescent plastic rings, each phosphorescent plastic ring removably couplable along the outer perimeter of one of the plurality of magnets.

13. The system of claim 12, wherein the set of phosphorescent plastic rings are configured to be biodegradable.

14. The system of claim 13, wherein the set of the phosphorescent plastic rings are individually colored in at least one of a plurality of colors.

15. The system of claim 1, wherein each of the plurality of magnets includes an adhesive backing configured to attach to a non-magnetic surface.

16. The system of claim 2, wherein each aperture includes a countersink on at least one side of said aperture.

17. A tool organization system comprising:
a plurality of magnets arranged in a set;
wherein each of the plurality of magnets includes at least one aperture;
wherein each aperture includes a countersink on at least one side of said aperture, and alternately, an adhesive backing configured to attach to a non-magnetic surface;
wherein at least one of the plurality of magnets has sufficient surface area to hold a plurality of fastening hardware;
wherein at least one of the plurality of magnets has sufficient surface area to hold a standard hammer;
wherein each of the plurality of magnets has an outer perimeter circumscribing an axis of polarity, and each of the plurality of magnets includes a peripheral coating on said outer perimeter;
wherein the plurality of magnets are configured with a beveled edge configured to be one-fourth inch in width from a forward facing position;
wherein the beveled edge is configured to be coated in phosphorescent paint;
wherein the peripheral coating of each of the plurality of magnets includes phosphorescent paint;
a container configured to house the plurality of magnets arranged in the set;
wherein the container has a volume at least large enough to house at least one set of the plurality of magnets; and
wherein the plurality of magnets are configured to be individually movable for arranging the plurality of magnets on a planar surface in any combination desired by a user to organize and store said tool organization system.

18. The system of claim 17, further comprising set of instructions; and
wherein the system is arranged as a kit.

19. A method of using a tool organization system, the method comprising the steps of:
providing the tool organization system;
attaching a plurality of magnets to a planar surface;
arranging the plurality of magnets in a desired configuration;
attaching a tool to a forward face of the plurality of magnets;
identifying the tool attached to the forward face of the plurality of magnets by the illumination of a phosphorescent paint; and
removing the tool as needed from the forward face of the plurality of magnets.

20. The method of claim 19, further comprising the step of:
storing the plurality of magnets in a container.
